(19) United States
(12) Patent Application Publication
(10) Pub. No.: US 2024/0062385 A1
(43) Pub. Date: Feb. 22, 2024

(54) METHOD, APPARATUS, AND NON-TRANSITORY COMPUTER-READABLE STORAGE MEDIUM STORING A PROGRAM FOR MONITORING MOTION IN VIDEO STREAM

(71) Applicant: NEC Corporation, Minato-ku, Tokyo (JP)

(72) Inventors: Ramarajulu SRINIVASAN, Singapore (SG); Masaharu MORIMOTO, Singapore (SG)

(73) Assignee: NEC Corporation, Minato-ku, Tokyo (JP)

(21) Appl. No.: 18/270,654

(22) PCT Filed: Jun. 30, 2022
(86) PCT No.: PCT/JP2022/026309

§ 371 Date: Jun. 30, 2023

(30) Foreign Application Priority Data
Aug. 6, 2021 (SG) 10202108637T

(51) Int. Cl. G06T 7/215; G06T 3/20; G06T 3/60

(52) U.S. Cl. CPC G06T 7/215; G06T 3/20; G06T 3/60; G06T 2207/10016; G06T 2207/30232

(57) ABSTRACT

Present disclosure provides methods and apparatuses for monitoring motion in a video stream. The method comprises: identifying a motion of interest from motion present in a virtual stream, the virtual stream covering an area of the video stream at which motion is present, the motion of interest being a motion that is targeted for monitoring, wherein the area of the video stream being covered is controllable by a pan tilt value of the virtual stream; and adjusting the pan tilt value of the virtual stream to position the motion of interest at a centre of the virtual stream.

### TECHNICAL FIELD

The present invention relates broadly, but not exclusively, to a method, an apparatus, and a system for monitoring motion in a video stream.

### BACKGROUND ART

Closed-circuit television (CCTV) surveillance systems are common in many areas of the world that require additional security or ongoing monitoring. Such areas encompass a great variety of venues like residential communities, public transport stations, shopping centres, banks, retail shops, office buildings and many other similar places. The technology is useful for crime prevention or deterrence and suspicious behavior analysis, for example to detect and prevent abnormal activities like fights, robberies, and other similar activities.

Manually monitoring video streams of CCTV surveillance systems is not possible, be it due to the size of the area being surveyed, the number of cameras being utilized, the amount of time (typically on a 24-7 basis) and attention required, and other factors. Fortunately, the advent of artificial intelligence (AI) has made it possible to monitor and detect abnormal activities from the video streams even in real time. AI systems that are utilized for the monitoring are usually powered by a graphics processing unit (GPU). However, such GPU based AI systems for video monitoring have a high cost making them prohibitive to use.

### SUMMARY OF INVENTION

### Technical Problem

Some surveillance systems may use one or more pan-tilt-zoom (PTZ) cameras, while others may use fisheye cameras which are able to cover a wider area than PTZ cameras. An issue that surveillance systems utilizing fisheye cameras may face is that the video stream input required by the AI systems is usually rectilinear which is different from the round video stream generated by a fisheye camera. In order to fully cover the area under surveillance by a fisheye feed, it is necessary to extract multiple rectilinear video streams that are cropped from the fisheye feed, thus requiring high processing power to do so.

Herein disclosed are embodiments of a device and methods for monitoring motion in a video stream that addresses one or more of the above problems.

Furthermore, other desirable features and characteristics will become apparent from the subsequent detailed description and the appended claims, taken in conjunction with the accompanying drawings and this background of the disclosure.

### Solution to Problem

In a first aspect, the present disclosure provides a method for monitoring motion in a video stream, the method comprising: identifying a motion of interest from motion present in a virtual stream, the virtual stream covering an area of the video stream at which motion is present, the motion of interest being a motion that is targeted for monitoring, wherein the area of the video stream being covered is controllable by a pan tilt value of the virtual stream; and adjusting the pan tilt value of the virtual stream to position the motion of interest at a centre of the virtual stream.

In a second aspect, the present disclosure provides an apparatus for monitoring motion in a video stream, comprising: a memory in communication with a processor, the memory storing a computer program recorded therein, the computer program being executable by the processor to cause the apparatus at least to: identify a motion of interest from motion present in a virtual stream, the virtual stream covering an area of the video stream at which motion is present, the motion of interest being a motion that is targeted for monitoring, wherein the area of the video stream being covered is controllable by a pan tilt value of the virtual stream; and adjust the pan tilt value of the virtual stream to position the motion of interest at a centre of the virtual stream.

In a third aspect, the present disclosure provides a system for monitoring motion in a video stream, comprising the apparatus as claimed in the second aspect and at least one video capturing device.

### BRIEF DESCRIPTION OF DRAWINGS

The accompanying Figures, where like reference numerals may refer to identical or functionally similar elements throughout the separate views and which together with the detailed description below are incorporated in and form part of the specification, serve to illustrate various embodiments and to explain various principles and advantages in accordance with a present embodiment, by way of non-limiting example only.

Embodiments of the invention will be better understood and readily apparent to one of ordinary skill in the art from the following written description, by way of example only, and in conjunction with the drawings, in which:

FIG. 1 shows an example illustration of a fisheye stream with multiple cropped rectilinear streams.

FIG. 2 depicts an example illustration of a conventional implementation of monitoring motion with fisheye streams.

FIG. 3 illustrates an example conventional system for monitoring motion with fisheye streams.

FIG. 4 illustrates a flow chart for a conventional workflow for monitoring motion with fisheye streams.

FIG. 5 depicts an illustration for a proposed implementation of monitoring motion with fisheye streams according to various embodiments of the present disclosure.

FIG. 6 depicts an example illustration of a proposed system for monitoring motion with fisheye streams according to various embodiments of the present disclosure.

FIG. 7 illustrates an example flowchart for a proposed workflow for monitoring motion with a fisheye stream according to various embodiments of the present disclosure.

FIGS. 8A-8D depict example illustrations of how a virtual stream is initialized according to various embodiments of the present disclosure.

FIG. 9 depicts an example illustration of how a virtual stream is initialized for motion detection in multiple areas according to various embodiments of the present disclosure.

FIG. 10 depicts example illustrations of how continuous pan, tilt and zoom for a virtual stream is implemented according to various embodiments of the present disclosure.

FIG. 11 depicts example illustrations of how a virtual stream is shut down according to an embodiment of the present disclosure.

FIG. 12 depicts example illustrations of how a virtual stream is shut down according to another embodiment of the present disclosure.

FIG. 13 depicts example illustrations of how a virtual stream is shut down according to another embodiment of the present disclosure.

FIG. 14 illustrates an example flowchart for monitoring motion in a video stream according to various embodiments of the present disclosure.

FIG. 15 depicts a block diagram illustrating a system for monitoring motion in a video stream according to various embodiments of the present disclosure.

FIG. 16 depicts an exemplary computing device that may be used to execute the methods of the earlier figures.

### DESCRIPTION OF EMBODIMENTS

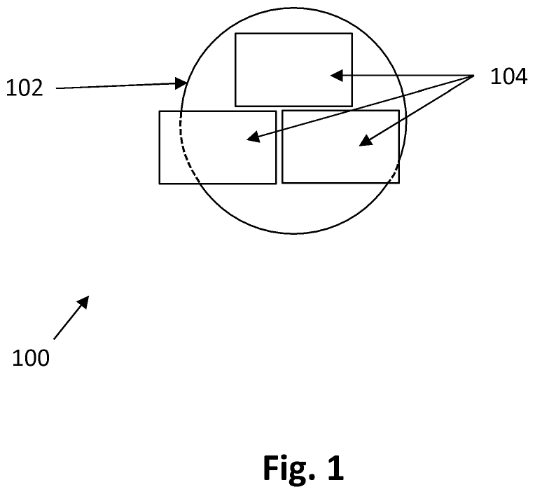

A fisheye stream is a video stream that is produced from a video camera having a fisheye lens. The fisheye lens is an ultra wide-angle lens that produces strong visual distortion intended to create a wide panoramic or hemispherical image. Fisheye lenses can achieve extremely wide angles of view that are typically wider than pan-tilt-zoom (PTZ) cameras. PTZ cameras are cameras that typically produce a video stream having straight lines of perspective view (e.g. a rectilinear video stream) and can be panned, tilted and zoomed physically to track objects in an area being covered. Instead of producing images with straight lines of perspective view (rectilinear images), fisheye lenses use a special mapping (for example equisolid angle), which gives images a characteristic convex non-rectilinear appearance. For example, FIG. 1 shows a representation of a fisheye stream 102. To monitor the area under surveillance by one fisheye feed using an AI system, multiple rectilinear video streams 104 need to be cropped and extracted from the fisheye stream 102 for analysis by the AI system.

When monitoring a video stream from a CCTV, various techniques may be utilized for detecting motion, or detecting an area of a video stream at which motion is present. For example, background subtraction may be used, in which areas of the video stream that are stationary are disregarded, and only areas in which pixels of the video stream are changing (for example, indicating presence of movement or motion) are being focused. Thereafter, one or more rectilinear streams may be generated to cover the areas with presence of motion, so that the AI system can use these rectilinear streams for further analysis. These rectilinear streams may be virtual streams that cover the areas in the video stream at which motion is present.

A motion of interest is a motion that is targeted for monitoring. Such motions may be predefined in an AI system. For example, the AI system may be configured to detect certain motions that resemble a fighting scene, a robbery scene, or other similar suspicious activity, for example in a video stream or a virtual stream.

### DETAILED DESCRIPTION

Where reference is made in any one or more of the accompanying drawings to steps and/or features, which may have the same reference numerals, those steps and/or features have for the purposes of this description the same function(s) or operation(s), unless the contrary intention appears.

It is to be noted that the discussions contained in the “Background” section and that above relating to prior art arrangements relate to discussions of devices which form public knowledge through their use. Such should not be interpreted as a representation by the present inventor(s) or the patent applicant that such devices in any way form part of the common general knowledge in the art.

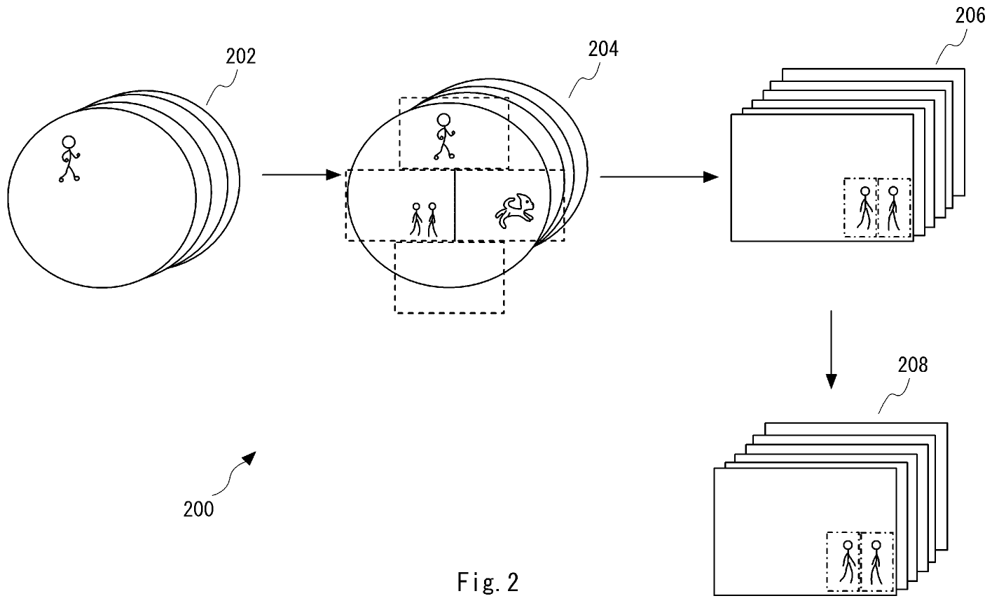

In an example conventional monitoring technique, an AI system is trained to detect abnormal actions directly from a fisheye video. This involves directly passing the fisheye video feed to the AI system, using the concerned fisheye camera's motion detection algorithm to trigger whether a video feed needs to be monitored by the AI system. FIG. 2 depicts an example illustration 200 of a conventional implementation of monitoring motion with fisheye streams. In a first step 202, M numbers of fisheye video streams may be input into an AI system. In a second step 204, each of the M fisheye streams is subdivided into N numbers of static rectilinear streams, each rectilinear streams covering a detected moving object. In a third step 206, the M×N numbers of rectilinear streams are analysed for movements or actions that are targeted for monitoring such as fighting, robbery, or other similar suspicious activity. In a fourth step 208, the targeted movements or actions are detected from each of the M×N rectilinear streams.

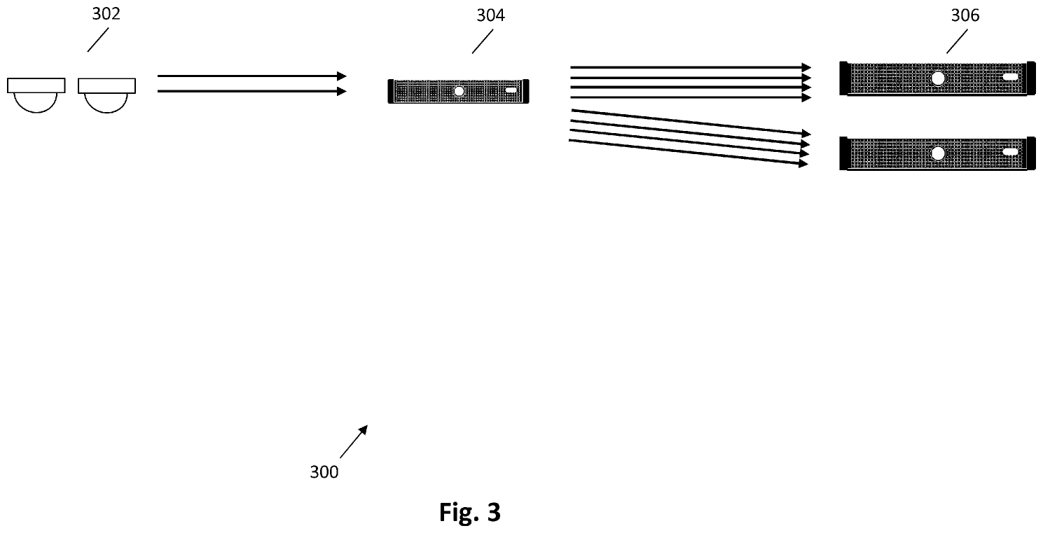

FIG. 3 illustrates an example conventional system 300 for monitoring motion with fisheye streams. In this conventional system 300, fisheye streams are recorded from fisheye CCTVs 302 directly to a Video Management Server (VMS) 304. By using functions in the VMS 304, a user can, for example, create M numbers of rectilinear streams from a single fisheye stream to monitor M numbers of moving objects detected in the fisheye stream. Each of these rectilinear streams will be assigned a universally unique identifier (UUID) by the VMS server 304, wherein a client may access a rectilinear stream from the VMS 304 by requesting for the stream which corresponds to the UUID. The UUIDs are statically assigned to analysis servers 306 with GPUs, such that each analysis server monitors and analyses one or more rectilinear streams that correspond to the assigned one or more UUIDs. All the rectilinear streams are continuously monitored at all times, making it difficult to scale the system when there are hundreds of CCTVs to be monitored.

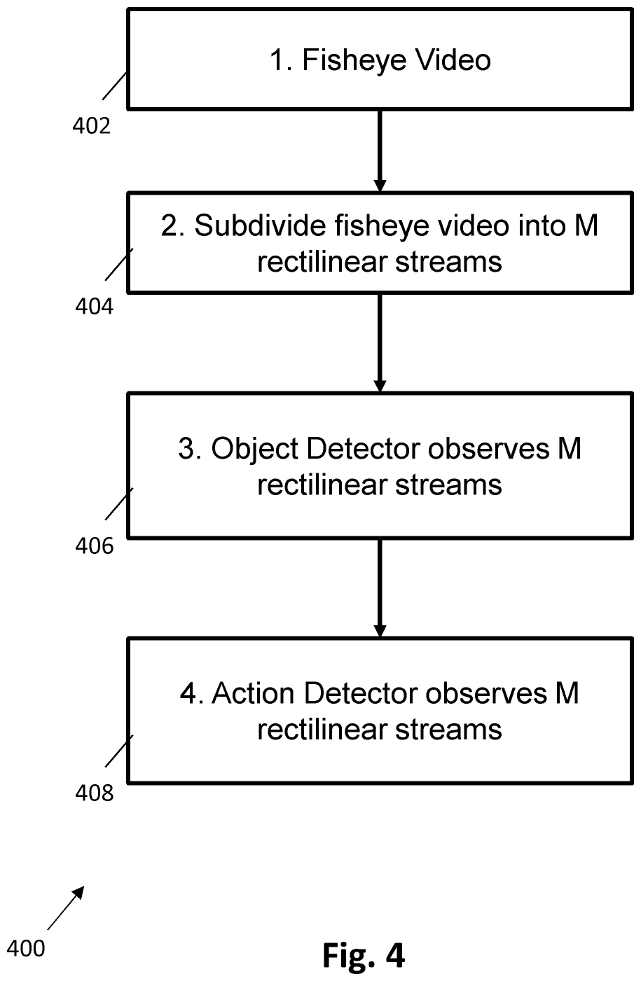

FIG. 4 illustrates a flow chart for a conventional workflow for monitoring motion with fisheye streams. At step 402, a fisheye video is generated from a fisheye camera. At step 404, the fisheye video is subdivided into M rectilinear streams. At step 406, an object detector observes the M rectilinear streams to detect an object that is targeted for monitoring. At step 408, an action detector observes the M rectilinear streams to detect an action that is targeted for monitoring.

While the above-described conventional implementation has a simpler system architecture, the AI architecture needs to be trained to work with the warped fisheye video streams. Further, the AI system needs to continuously monitor all the fisheye streams if a plurality of fisheye streams are fed into the AI system, increasing the required processing load.

In another example of a conventional monitoring technique, PTZ cameras may be used instead of fisheye cameras. PTZ cameras can be panned, tilted and zoomed physically to track objects in an area being covered. While PTZ cameras can optically zoom in to provide a clearer and bigger view of a targeted object, area of coverage for PTZ cameras is limited, such that multiple PTZ cameras may need to be installed to get complete coverage of an area such as a room. Further, an AI monitoring system will need to continuously monitor multiple video streams at a same time if a plurality of PTZ cameras are used, increasing the required processing load.

According to various embodiments of the present disclosure, low-cost central processing unit (CPU) based background subtraction methods may be used for monitoring a video feed, such that it is possible to pan and zoom into a fisheye video feed to extract and monitor only the regions which have motion detected in them via generation of one or more virtual streams that cover these regions. An AI system for monitoring the video stream(s) and virtual stream(s) can also feedback to the background subtraction program to pan, tilt & zoom in the video stream to adjust the area covered by the virtual streams, or shut down the virtual streams. Advantageously, existing camera infrastructures can still be utilized with this proposed monitoring method. The cost of implementation is lowered due to the low-cost CPUs. It is also possible to co-locate one or more GPU servers on site, instead of streaming the video feeds to a datacenter. By utilizing rectilinear virtual streams, it is possible to train the AI system on publicly available rectilinear image datasets and use popular AI model architectures for implementing the proposed monitoring method. Further, by dynamically pan, tilt and zooming an area covered by a virtual stream to keep objects in a center of the virtual stream, accuracy of detection of a motion of interest is increased, since behaviour detection for an AI system is typically trained with actions which occur mostly at a center of a frame.

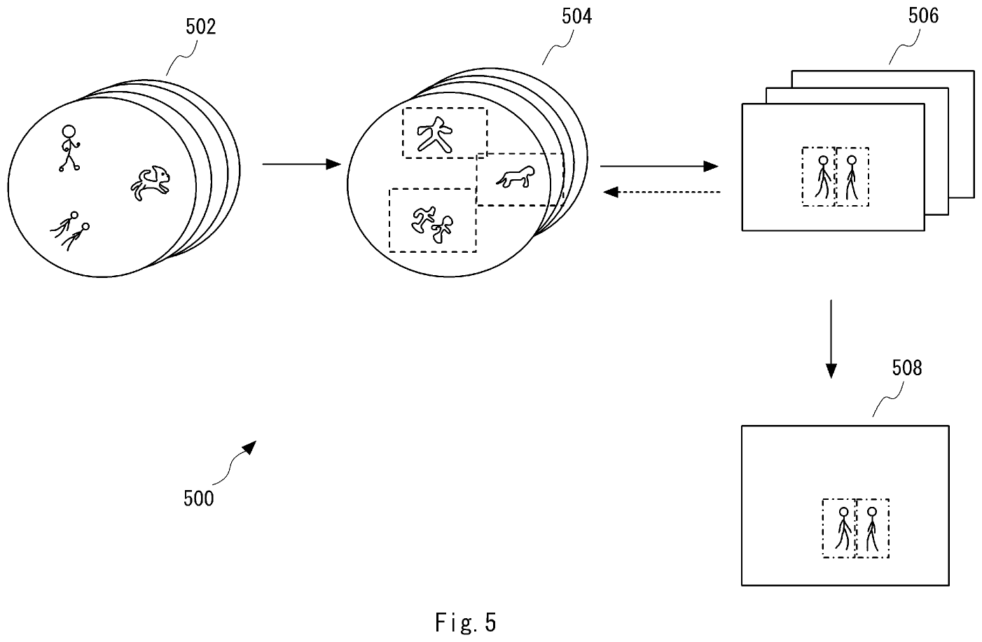

FIG. 5 depicts an illustration 500 for a proposed implementation of monitoring motion with fisheye streams according to various embodiments of the present disclosure. At step 502, M numbers of fisheye streams may be generated from a M numbers of fisheye cameras. At step 504, motion may be detected from X numbers of areas from the M fisheye streams. X numbers of dynamically instantiated rectilinear streams such as virtual streams may be generated to cover the X areas from the fisheye streams at which motion is present. The area of a fisheye video stream being covered by a virtual stream may be controllable by a pan tilt value of the virtual stream for continuous tracking and monitoring of, for example, a moving object. At step 506, only fisheye streams with motion detected are filtered for further observation, wherein the X numbers of virtual streams are observed to identify motions of interest from motion present in the virtual streams. The motions of interest may be motions that are targeted for monitoring. For example, there may be Y numbers of virtual streams in which no motions of interest are identified. Therefore, at step 508, these Y virtual streams are filtered out from the X numbers of virtual streams so that only X minus Y numbers of virtual streams are required for further analysis and monitoring. For these X minus Y numbers of virtual streams, an averaged center coordinate of detected motions of interest in each virtual stream may be calculated and used for shifting the position of the appropriate virtual stream to keep each detected motion of interest at the center of the virtual stream.

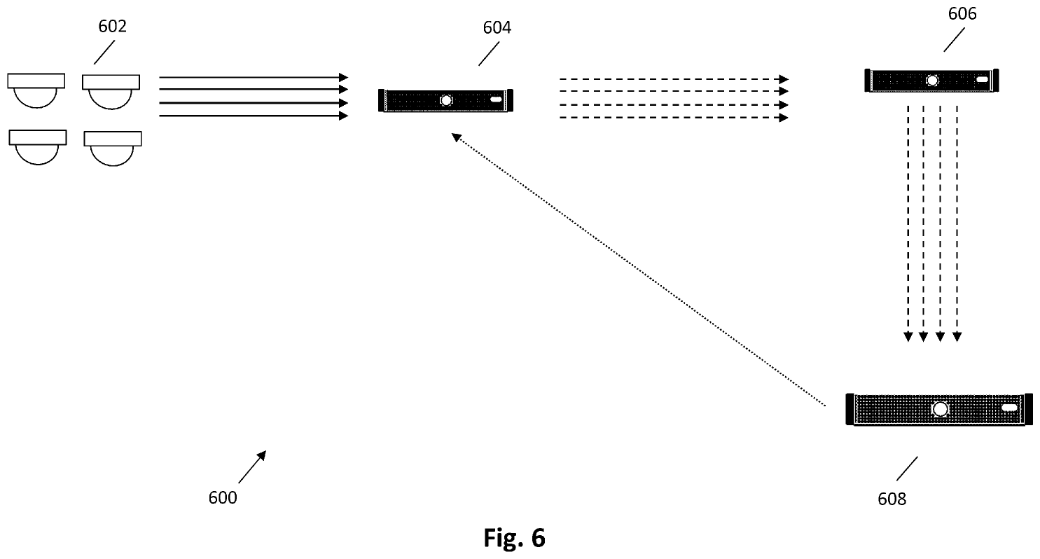

FIG. 6 depicts an example illustration of a proposed system 600 for monitoring motion with fisheye streams according to various embodiments of the present disclosure. In the proposed system 600, one or more fisheye streams from one or more fisheye cameras 602 are observed by a motion detection, stream creation and GPU assignment server (SCS) 604. This SCS server 604 observes the one or more fisheye streams, and upon detection of motion in an area of a fisheye stream, the SCS instantiates a video stream such as a virtual stream to encompass this detected motion area and publishes said virtual stream to a next unused real time streaming protocol (RTSP) universal resource locator (URL) among a list of predefined RTSP URLs. A VMS 606 which is listening to this list of predefined RTSP URLs reads the new stream and starts recording it. The VMS 606 then rebroadcasts this virtual stream. This virtual stream is mapped to a fixed UUID by the VMS 606 for each RTSP URL, and a client can request for the virtual stream by requesting for the virtual stream's UUID from the VMS 606. The SCS 604 maintains a database of RTSP URLs and their corresponding VMS UUIDs, as well as analysis or GPU servers 608 and their respective assigned virtual streams. Upon creation of a virtual stream, the SCS 604 by looking up this database, assigns said VMS UUID to one of the analysis servers 608, by means of either calling a representational state transfer (REST) URL on the analysis server or publishing a message to a messaging server (not shown) which the analysis servers 608 are subscribed to. Each analysis server also communicates with the SCS 604 in order to: (1) pan and zoom the rectilinear virtual streams, so as to keep the detected objects in a virtual stream at the center of the virtual stream; (2) shut down a virtual stream, if the objects in the virtual stream or their activities do not meet criteria for observation, for example due to being stationary for a period of time; (3) shut down a virtual stream, and regenerate the virtual stream or recreate a new virtual stream when the identified motion of interest is moving and deviating from a previous position; and (4) shut down a virtual stream if a plurality of motion of interest are identified in the virtual stream, and generate or create a plurality of new virtual streams, each of the new virtual streams covering an area of the video stream at which each of the plurality of motion of interest is present.

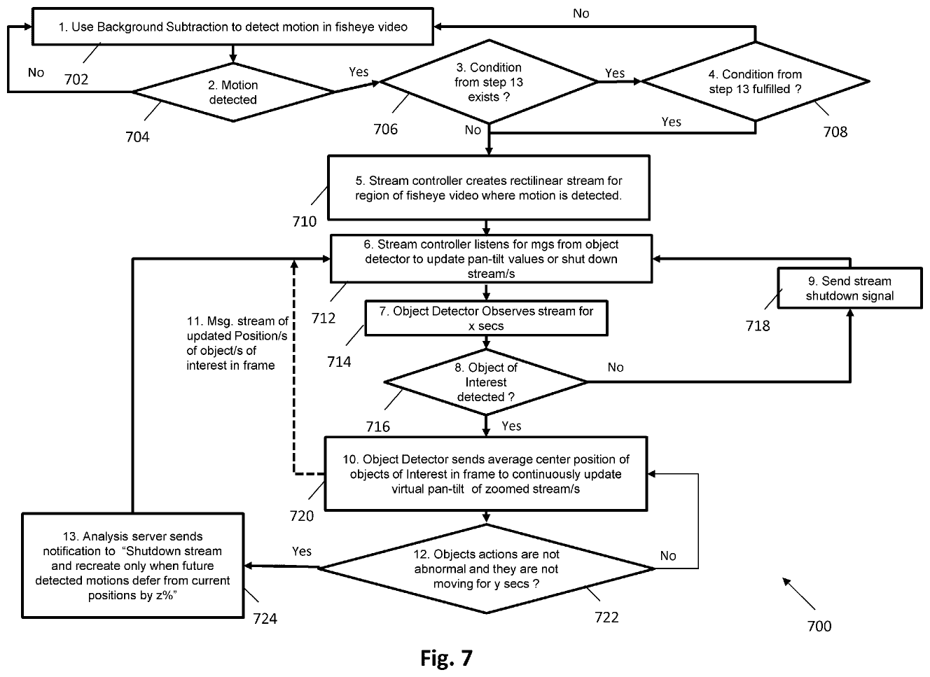

FIG. 7 illustrates an example flowchart 700 for a proposed workflow for monitoring motion with a fisheye stream according to various embodiments of the present disclosure. At step 702, background subtraction is utilized to detect motion in a fisheye video stream, which may comprise detecting the area at which motion is present in the video stream, disregarding areas of the video stream that are stationary and generating a virtual stream to cover an area of the video stream that is moving. At step 704, it is determined whether motion is detected. If motion is not detected, the process returns to step 702. Otherwise, the process proceeds to step 704, where it is determined whether a condition from step 724 exists. If the condition exists, the process proceeds to step 708 where it is determined if the condition required in step 724 is fulfilled. If it is determined that the condition is not fulfilled, the process returns to step 702. Otherwise, if it is determined in step 706 that the condition from step 724 exists, or if it is determined in step 708 that the condition in step 724 is fulfilled, the process proceeds to step 710 where a stream controller creates or generates a rectilinear stream such as a virtual stream for a region of the fisheye video stream where the motion is detected. At step 712, the stream controller listens for messages from an object detector to update pan-tilt values of the virtual stream or shut down the virtual stream. At step 714, the object detector observes the virtual stream for a period of time such as X seconds. At step 716, it is determined if an object or motion of interest is detected. If it is determined that an object or motion of interest is not detected, the process proceeds to step 718 where the object detector sends a signal to the stream controller to shut down the virtual stream. The process then returns to step 712. Otherwise, if an object or motion of interest is detected at step 716, the process proceeds to step 720 where the object detector sends an average centre position of the detected object of interest in the video stream frame to continuously update a virtual pan-tilt value of the virtual stream. For example, a coordinate corresponding to a centre of the motion of interest in the video stream may be determined, and the pan tilt value of the virtual stream may be adjusted to position the centre of the virtual stream at the determined coordinate. The object detector may send a continuous stream of updated positions of the object or motion of interest to the stream controller, so that the object or motion of interest can be constantly kept in position at the centre of the virtual stream. Further, adjusting the pan tilt value of the virtual stream may be done in real time. At step 722, it is determined, for example by an analysis server, whether the object or motion of interest is abnormal or stationary for a period of time such as Y seconds. If it is determined that the object or motion of interest is not abnormal or stationary, the process returns to step 720. Otherwise, the process proceeds to step 724 where a message or notification is sent to shut down the virtual stream. For example, the analysis server may send a notification to the stream controller to shut down the virtual stream and regenerate or recreate the virtual stream only when a future detected motion defers from a current position by a certain percentage.

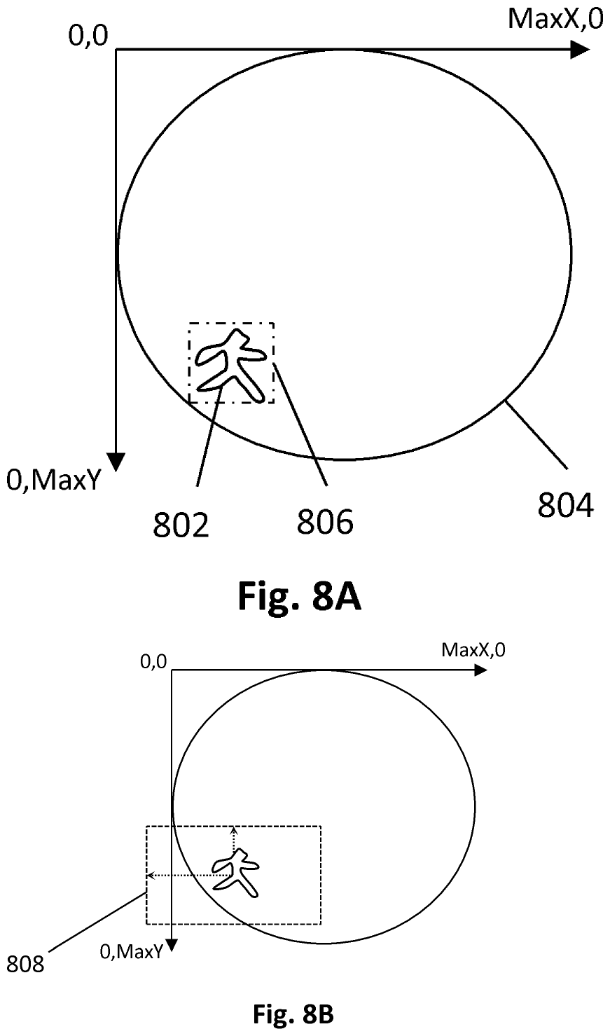

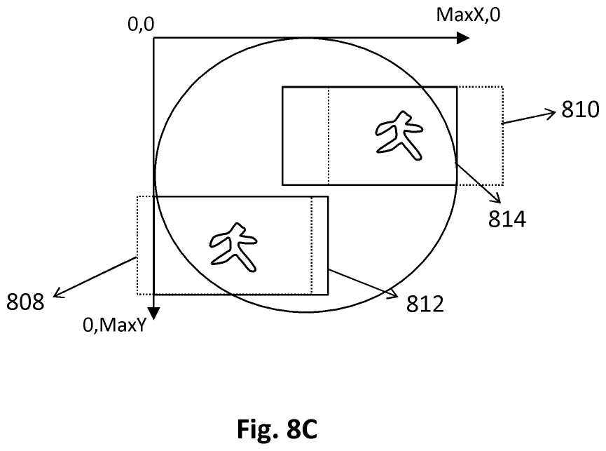

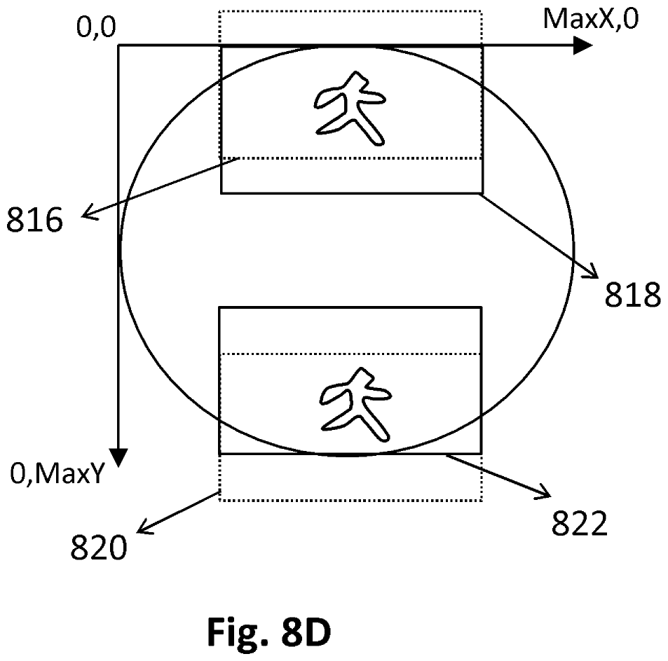

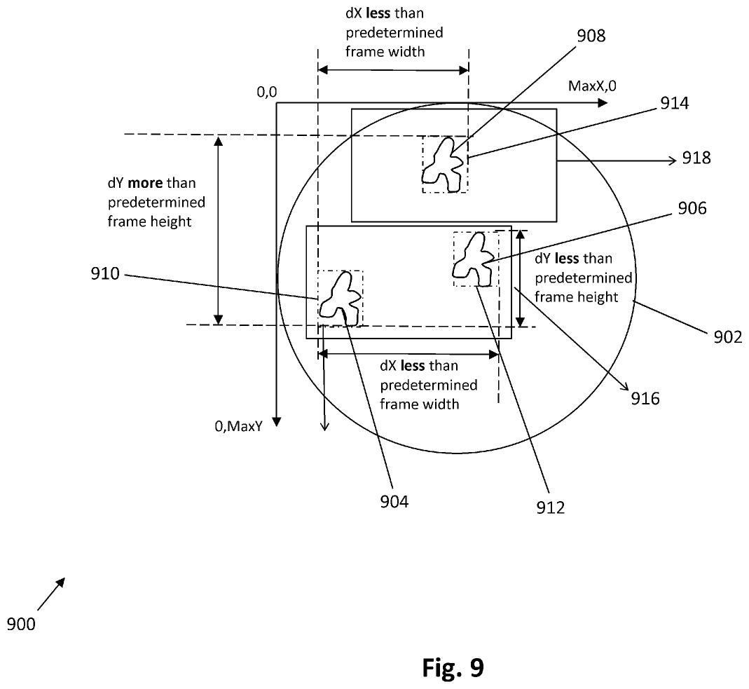

FIGS. 8A-8D depict example illustrations of how a virtual stream is initialized according to various embodiments of the present disclosure. Upon motion detection, for example a motion 802 in fisheye video stream 804 of FIG. 8A, a bounding box 806 may be determined around the motion 802 using, for example, methods such as OpenCV's findContours function. A center of the detected motion 802 may be calculated using coordinates of this bounding box 806. The center of the detected motion 802 may comprise coordinates CX (e.g. X-coordinates of a center of the bounding box 806 around the detected motion 802) and CY (e.g. Y-coordinates of the center of the bounding box 806 around the detected motion 802). An initial position for a rectilinear frame 808 of a virtual stream in FIG. 8B for covering the detected motion 802 may be calculated using the center of the bounding box 806 as reference. The rectilinear frame 808 may comprise a top left coordinate having a XTL and YTL (e.g. a top left X coordinate and a top left Y coordinate), a top right coordinate having a XTR and YTR (e.g. a top right X coordinate and a top right Y coordinate), a bottom left coordinate having a XBL and YBL (e.g. a bottom left X coordinate and a bottom left Y coordinate), and a bottom right coordinate having a XBR and YBR (e.g. a bottom right X coordinate and a bottom right Y coordinate). Each of the X and Y coordinates, for example XTL, YTL, XBR and YBR of the rectilinear frame 808, may be calculated as follows:

XTL=CX−(Pre-determined width/2)

YTL=CY−(Pre-determine height/2)

XBR=XTL+Pre-determined width

YBR=YTL+Pre-determined height

For a rectilinear frame having a resolution of, for example, 1280×720 pixels, the pre-determined width is 1280 pixels while the pre-determined height is 720 pixels. It will be appreciated that other higher or lower resolutions are also possible.

The initial rectilinear frame of a virtual stream may be adjusted so that the frame does not extend over a boundary of the fisheye stream 804. For example, fisheye stream 804 may be defined by a minimum X value of zero, a maximum X value MaxX, a minimum Y value of zero, and a maximum Y value MaxY.

Accordingly, minimum and maximum coordinate positions may be imposed on the initial position of rectilinear frames 808 and 810 in FIG. 8C, as well as the initial position of rectilinear frames 816 and 818 in FIG. 8D, wherein coordinates of top right and bottom left corners of each rectilinear frame are checked to see if they lie between 0 and MaxX for the X coordinates, and between 0 and MaxY for the Y coordinates. For example, in fulfilling these requirements, rectilinear frame 808 may be adjusted based on the following calculations:

If XTL<0:

new XBR=current XBR+|XTL|

new XTL=0

If XBL>MaxX:

new XBR=old XBR−(XBL−MaxX)

If YTL<0:

new YBR=current YBR+|YTL|

new YTL=0

If YBL>MaxY:

new YBR=old YBR−(YBL−MaxY)

By applying these calculations, the initial position of rectilinear frame 808 may be adjusted to frame position 812, the initial position of rectilinear frame 810 may be adjusted to frame position 814, the initial position of rectilinear frame 816 may be adjusted to frame position 820, and the initial position of rectilinear frame 818 may be adjusted to frame position 822.

FIG. 9 depicts an example illustration 900 of how a virtual stream is initialized for motion detection in multiple areas according to various embodiments of the present disclosure. When motion areas 904, 906 and 908 are detected in a fisheye stream 902, bounding boxes 910, 912, and 914 of the respective motion areas are calculated using established algorithms (e.g. OpenCV's findContours function). Coordinates for the bounding boxes may be kept in a list and the following algorithm may be used to see if a motion detection region can fit into a single rectilinear image frame or separate frames are required (using the same coordinate terminology as described in FIGS. 8A-8D):
1. Iterate through the list of bounding boxes and find the bounding box with the lowest XTL value (e.g. LMBB). In the present example, the bounding box with the lowest XTL value would be bounding box 910.
2. Iterate through the list again and calculate difference dX between the XTL value of the LMBB and XTR value of the other bounding boxes 912 and 914 in the list.
3. If the difference dX calculated above is less than a pre-determined frame width for a rectilinear virtual stream, compare the YTL value of the LMBB against the YTL of the bounding box being compared:
   a. If the YTL of the LMBB is less than the YTL value of the bounding box being compared, that means the LMBB is higher in position in the fisheye stream 902 than the bounding box being compared, so the difference dY between the YTL of the LMBB and the YBL of the bounding box being compared is noted.
   b. If the YTL of the LMBB is more than the YTL of the bounding box being compared, that means the LMBB is lower in position in the fisheye stream 902 than the bounding box being compared, so the difference dY between the YBL of the LMBB and the YTL of the bounding box being compared is noted.
   c. If the Y coordinate difference dY calculated in steps 3a or 3b is less than a predetermined frame height of a rectilinear virtual stream, the bounding box being compared will be included in a group of bounding boxes that will be used for calculating a center position of a rectilinear frame e.g. a rectilinear frame of a virtual stream for covering the LMBB and the motion area of the bounding box being compared.
4. For bounding boxes which are in the same group as determined by step 3c, calculate their individual center points and use that to get an average center point (ACP) of all the bounding boxes in the group.
5. Initialize a rectilinear stream to have its center position at the ACP.
6. Shift the rectilinear stream's position using the shift formula described in FIGS. 8A-8D.
7. If there exists bounding boxes which fail the criteria required in step 3, step 3 is repeated for those bounding boxes.
8. If the bounding boxes are still not able to be grouped after, for example, four rounds of step 6, a separate rectilinear virtual stream is created for each of these bounding boxes.

In the present example, motion areas 904 and 906 are grouped into a virtual stream 916 since their positions in the fisheye stream 902 enable them to be captured in a single virtual stream, while a separate virtual stream 918 covers motion area 908. Thus, one or more virtual streams (e.g. virtual streams 916 and 918) each with a frame of a predetermined height and width may be generated, wherein each virtual stream may cover one or more areas of the video stream at which motion is present. A plurality of areas at which motion is present (e.g. motion areas 904, 906 and 908) may be detected in the video stream. The plurality of areas may be divided into one or more groups are shown in step 3c above, each group comprising at least two areas, wherein the at least two areas occupy a total height and width in the video stream that do not exceed the predetermined height and width of the frame of the virtual stream respectively. Each of the one or more virtual streams may then be generated to cover each of the one or more groups. The generation of each of the one or more virtual streams may further comprise determining a coordinate for a centre of each of the plurality of areas (e.g. motion areas 904, 906 and 908), and calculating an average centre coordinate (e.g. the ACP as shown in step 4 above) for each group based on an average of the determined coordinate of each of the at least two areas in each group, wherein a centre of the frame of each generated virtual stream is positioned at the average centre coordinate for an associated group as shown in step 5. Generating the one or more virtual streams may further comprise adjusting the pan tilt value of each virtual stream to position each frame within a boundary of the video stream (e.g. the fisheye video stream 902).

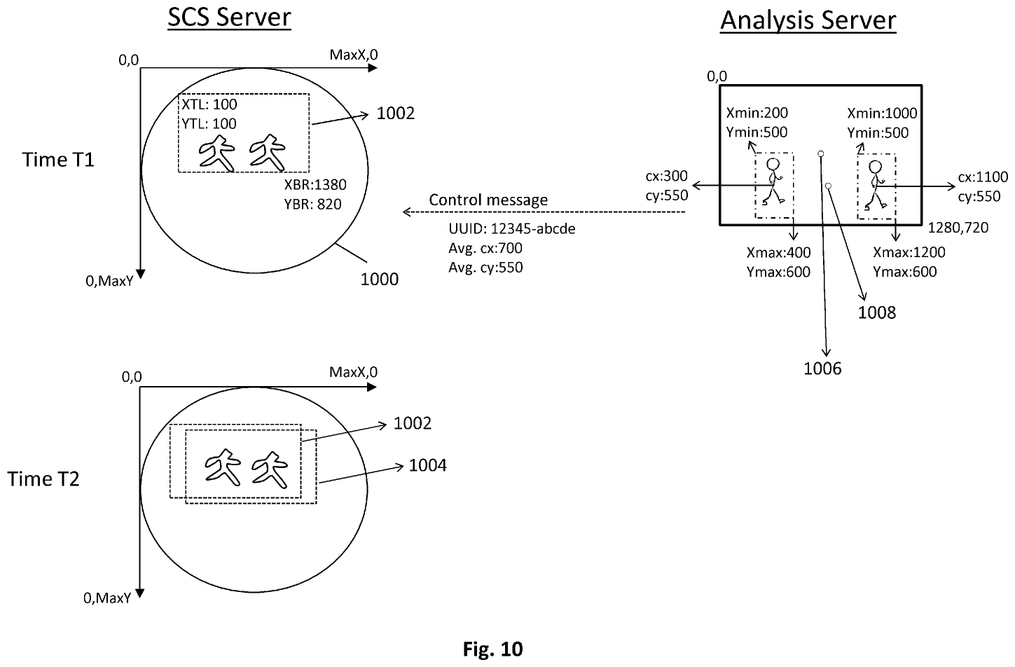

Furthermore, the average centre coordinate for each group may be updated in real time, and the pan tilt value of each virtual stream may be adjusted to position the centre of the frame at the updated average centre coordinate. FIG. 10 depicts example illustrations of how continuous pan, tilt and zoom for a virtual stream is implemented according to various embodiments of the present disclosure. At a time T1, a virtual stream having rectilinear frame 1002 is fully initialized in a SCS for a fisheye stream 1000 and the virtual stream is sent to the VMS via RTSP. An analysis server, for example by means of an object detector, determines the bounding boxes of the objects or motion areas in the frame 1002. An average of the center position of all the objects or motion areas in the frame 1002 is calculated and sent to the SCS. The analysis server sends a UUID of the current rectilinear stream 1002 and the average center position back to the SCS. At a time T2 (e.g. T2 being a point in time that is after T1), the SCS then shifts the position of the rectilinear frame 1002 to a new position 1004 so as to place the average position sent by the analysis server at the center of the rectilinear frame.

For example, the initial centre position of the rectilinear frame 1002 may be represented as reference 1006, while the average centre position of objects or motion areas may be represented as reference 1008 having X coordinate 700 and Y coordinate 550. To achieve an optimal position wherein the average centre position of the objects or motion areas are at the centre of the rectilinear frame, the following calculations may be performed to determine how the pan-tilt value of the associated virtual stream should be shifted:
If the frame's width=1280 and Height=720
Frame centre x coordinate (cx): 1280/2=640
Frame centre y coordinate (cy): 720/2=360

Thus, frame shift required is

X−>700−640=60(Avg. cx−Frame cx)

Y−>550−360=190(Avg. cx−Frame cx)

Thus, the pan-tilt value of the virtual stream should be adjusted such that the rectilinear frame 1002 shifts +60 pixels in the x-axis and +190 pixels in the y-axis. This process may be done continuously at the object detector's frame rate. A motion detector may stop detecting motion after a period of time when the object or motion of interest stops moving. Therefore, an object detector may be used to get the bounding box instead in the event the object or motion of interest stops moving.

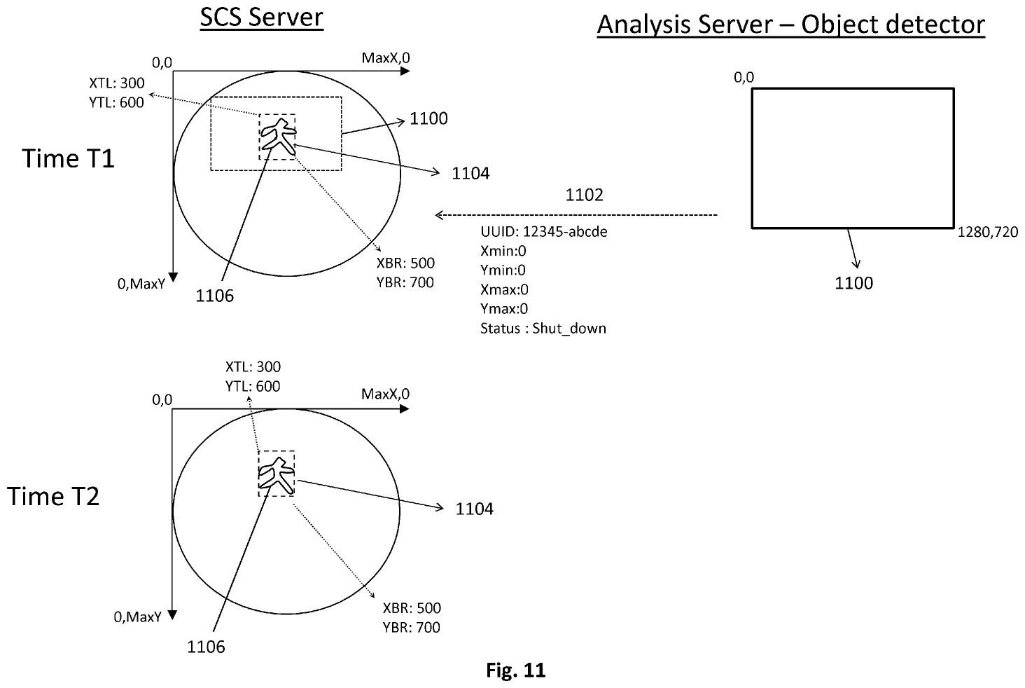

FIG. 11 depicts example illustrations of how a virtual stream is shut down according to an embodiment of the present disclosure. For example, an object detector of an analysis server may be unable to detect any objects or motion areas in a virtual stream (e.g. no objects identified in rectilinear frame 1100 of a virtual stream as shown in the right side of FIG. 11) after a user definable time period, so it sends a “shutdown” control message 1102 indicating, for example, a value ‘0’ for object coordinates to an SCS server. The SCS server uses a bounding box 1104 (e.g. bounding box defined by a motion detector) of the concerned motion area 1106 to set up ignore areas, such that further motion within the area bounded by the bounding area 1104 are disregarded. This ‘ignore’ condition may be removed when subsequent motion is detected overlapping with the area within the bounding box 1104, for example with a user-definable minimum and maximum percentage of overlap.

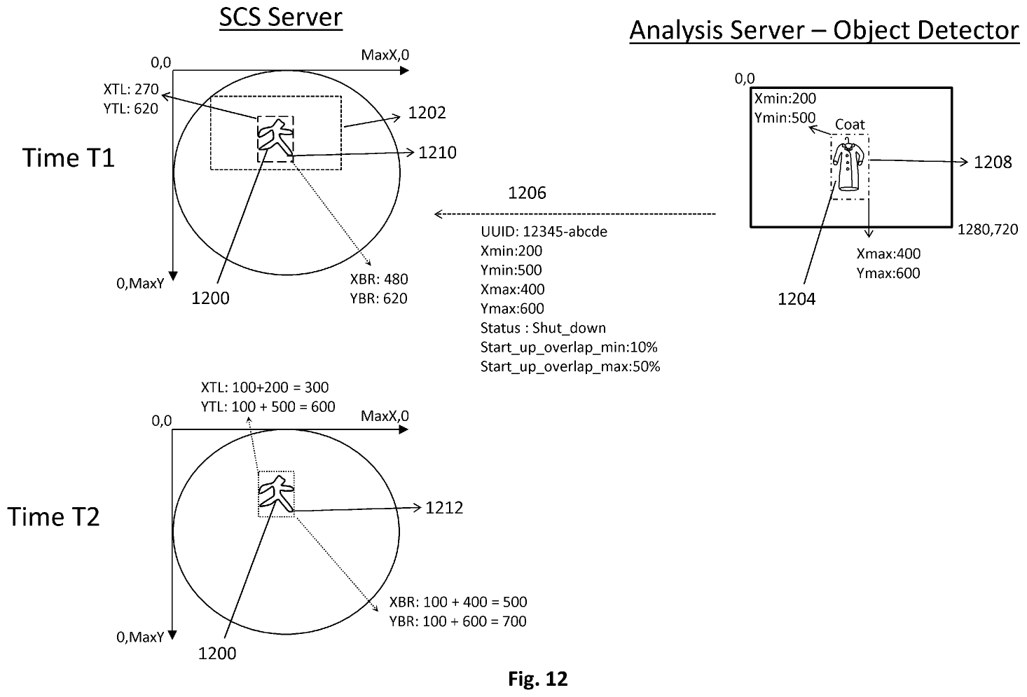

FIG. 12 depicts example illustrations of how a virtual stream is shut down according to another embodiment of the present disclosure. For example, at a time T1 in the upper left of FIG. 12, a motion detector of a SCS server may detect an area 1200 in which motion is present and a virtual stream 1202 is generated to cover the area 1200. However, an object detector of an analysis server (see the right side of FIG. 12) may detect an object 1204 in the virtual stream 1202 that may not be an object or motion of interest. For example, the object 1204 may be coat that may be moving due to strong winds. The object detector may then send coordinates 1206 associated with a bounding box 1208 of the object 1204 to the SCS server. The coordinates 1206 may be compared against coordinates associated with motion detectors bounding box 1210 of area 1200 to determine if there is an overlap, for example by using a Union of Intersection algorithm to compare each of the objects detected (e.g. object 1204) against the motion detectors bounding box 1210. For example, if it is determined from the comparison that there is 50% or more overlap with the bounding box 1210, it is assumed that the object detector has detected the object causing the motion detection. Therefore, at a time T2 in lower left of FIG. 12, the SCS server uses an updated bounding box 1212 (e.g. an updated bounding box due to motion detected by the motion detector) of the concerned motion area 1200 to set up ignore areas, such that further motion within the area bounded by the bounding area 1212 are disregarded. Further, the virtual stream 1202 is shut down. This ‘ignore’ condition may be removed when subsequent motion is detected overlapping with the area within the bounding box 1212, for example with a user-definable minimum and maximum percentage of overlap.

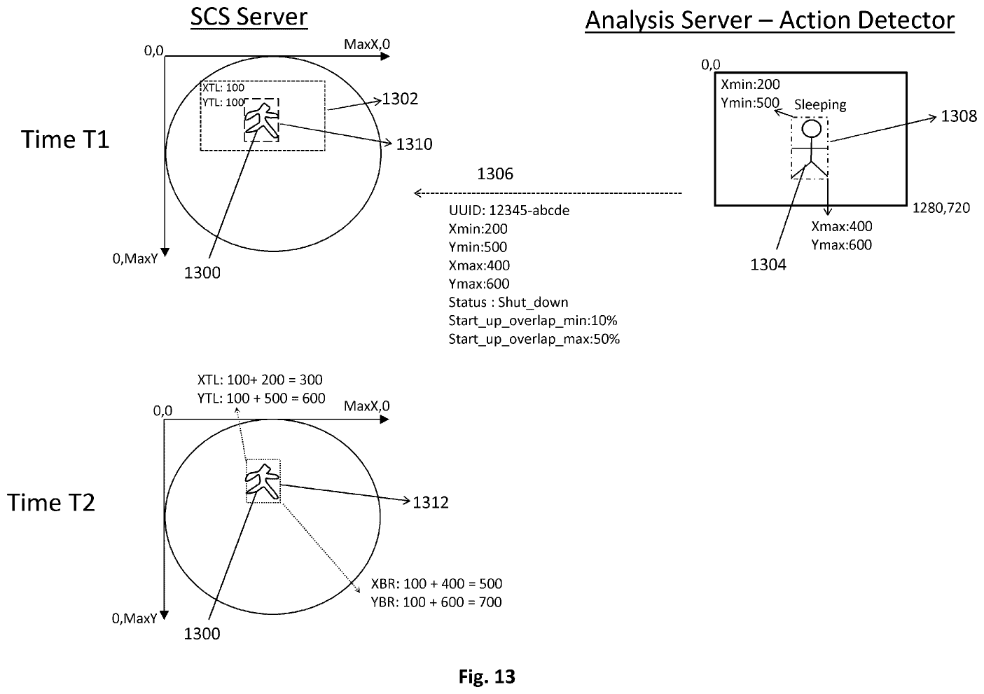

FIG. 13 depicts example illustrations of how a virtual stream is shut down according to another embodiment of the present disclosure. For example, at a time T1 in Fig. the upper left of 13, a motion detector of a SCS server may detect an area 1300 in which motion is present and a virtual stream 1302 is generated to cover the area 1300. However, a behaviour detector of an analysis server (see the right side of FIG. 13) may detect a behaviour 1304 in the virtual stream 1302 that may not be a motion of interest. For example, the behaviour 1304 may be detected as “sleeping”. Such a behaviour may not be an object or motion of interest, and an area of bounding box 1308 of the behaviour 1304 may be x % similar for a user-definable period of time. The behaviour detector may then send coordinates 1306 associated with the bounding box 1308 of the behaviour 1304 to the SCS server. The coordinates 1306 may be compared against coordinates associated with motion detectors bounding box 1310 of area 1300 to determine if there is an overlap, for example by using a Union of Intersection algorithm to compare each of the objects detected (e.g. behaviour 1304) against the motion detectors bounding box 1310. For example, if it is determined from the comparison that there is 50% or more overlap with the bounding box 1210, it is assumed that the behaviour detector has detected the behaviour causing the motion detection. Therefore, at a time T2 in the lower left of FIG. 13, the SCS server uses an updated bounding box 1312 (e.g. an updated bounding box due to motion detected by the motion detector) of the concerned motion area 1300 to set up ignore areas, such that further motion within the area bounded by the bounding area 1312 are disregarded. Further, the virtual stream 1302 is shut down. This ‘ignore’ condition may be removed when subsequent motion is detected overlapping with the area within the bounding box 1312, for example with a user-definable minimum and maximum percentage of overlap.

In summary, the differences between the proposed system and conventional systems are (1) dynamic rectilinear stream creation from fisheye videos based on the detection of motion in the fisheye videos, the position of said stream created so as to place the motion region in the center of said stream; (2) shifting of the rectilinear streams based on the detected positions of objects of interest in the stream, so as to optimise inter-person activity detection; (3) dynamic shutting down of the created rectilinear streams upon feedback from the object detector; and (4) recreation or regeneration of the dynamic rectilinear streams only when the motion detected in the fisheye video fulfils user-definable conditions.

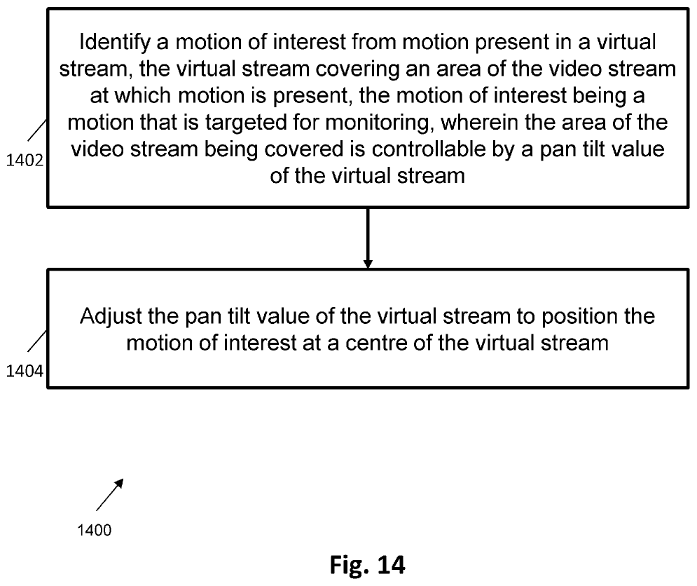

FIG. 14 illustrates an example flowchart 1400 for monitoring motion in a video stream according to various embodiments of the present disclosure. At step 1402, a motion of interest is identified from motion present in a virtual stream, the virtual stream covering an area of the video stream at which motion is present, the motion of interest being a motion that is targeted for monitoring, wherein the area of the video stream being covered is controllable by a pan tilt value of the virtual stream. At step 1404, the pan tilt value of the virtual stream is adjusted to position the motion of interest at a centre of the virtual stream.

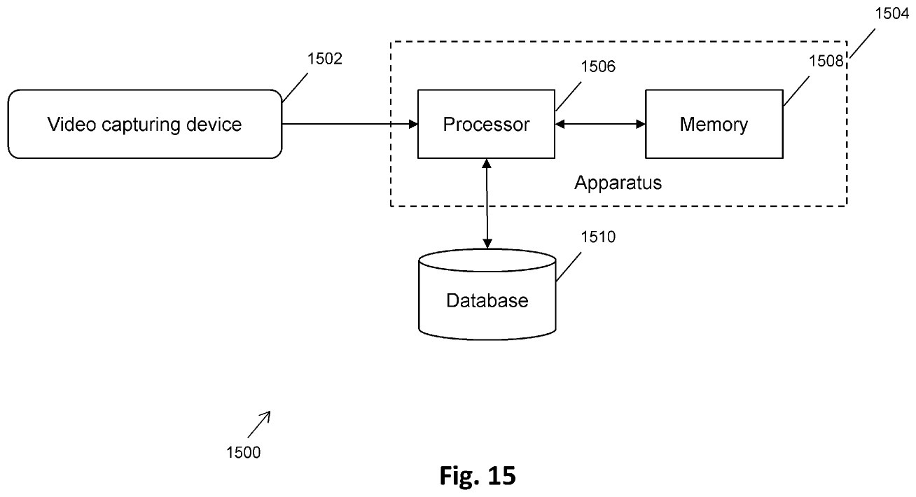

FIG. 15 depicts a block diagram illustrating a system 1500 for monitoring motion in a video stream according to various embodiments. In an example, the managing of video input stream is performed by at least a video capturing device 1502 and an apparatus 1504. The system 1500 comprises the video capturing device 1502 in communication with the apparatus 1504. In an implementation, the apparatus 1504 may be generally described as a physical device comprising at least one processor 1506 and at least one memory 1508 including computer program code. The at least one memory 1508 and the computer program code are configured to, with the at least one processor 1506, cause the physical device to perform the operations described in FIG. 7 and/or FIG. 10. The processor 1506 is configured to receive a video stream from the video capturing device 1502 or to retrieve a video stream from a database 1510.

The video capturing device 1502 may be a device in which a video stream can be input. For example, a digital video can be input, or a physical copy of a video can be input such that the video is being used as an input. The video capturing device 1502 may also be a video camera such as a CCTV camera with which a video stream can be produced and used as an input video stream for the apparatus 1504. The video capturing device 1502 may also be a video camera such as a fisheye camera with which a video stream can be produced and used as an input video stream for the apparatus 1504.

The apparatus 1504 may be configured to communicate with the image capturing device 1502 and the database 1510. In an example, the apparatus 1504 may receive, from the video capturing device 1502, or retrieve from the database 1510, a input video stream, and after processing by the processor 1506 in apparatus 1504, identify a motion of interest from motion present in a virtual stream, the virtual stream covering an area of the video stream at which motion is present, the motion of interest being a motion that is targeted for monitoring, wherein the area of the video stream being covered is controllable by a pan tilt value of the virtual stream, and then adjust the pan tilt value of the virtual stream to position the motion of interest at a centre of the virtual stream.

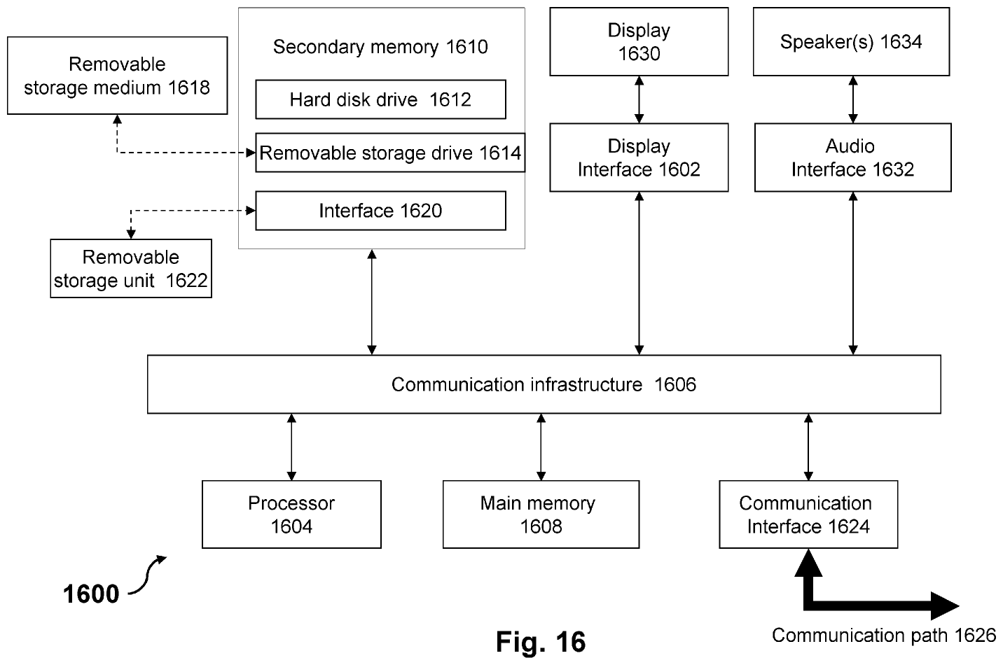

FIG. 16 depicts an exemplary computing device 1600, hereinafter interchangeably referred to as a computer system 1600 or as a device 1600, where one or more such computing devices 1600 may be used to implement the system 1500 shown in FIG. 15 or the method of the earlier figures. The following description of the computing device 1600 is provided by way of example only and is not intended to be limiting.

As shown in FIG. 16, the example computing device 1600 includes a processor 1604 for executing software routines. Although a single processor is shown for the sake of clarity, the computing device 1600 may also include a multi-processor system. The processor 1604 is connected to a communication infrastructure 1606 for communication with other components of the computing device 1600. The communication infrastructure 1606 may include, for example, a communications bus, cross-bar, or network.

The computing device 1600 further includes a primary memory 1608, such as a random access memory (RAM), and a secondary memory 1610. The secondary memory 1610 may include, for example, a storage drive 1612, which may be a hard disk drive, a solid state drive or a hybrid drive and/or a removable storage drive 1614, which may include a magnetic tape drive, an optical disk drive, a solid state storage drive (such as a USB flash drive, a flash memory device, a solid state drive or a memory card), or the like. The removable storage drive 1614 reads from and/or writes to a removable storage medium 1618 in a well-known manner. The removable storage medium 1618 may include magnetic tape, optical disk, non-volatile memory storage medium, or the like, which is read by and written to by removable storage drive 1614. As will be appreciated by persons skilled in the relevant art(s), the removable storage medium 1618 includes a computer readable storage medium having stored therein computer executable program code instructions and/or data.

In an alternative implementation, the secondary memory 1610 may additionally or alternatively include other similar means for allowing computer programs or other instructions to be loaded into the computing device 1600. Such means can include, for example, a removable storage unit 1622 and an interface 1620. Examples of a removable storage unit 1622 and interface 1620 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 1622 and interfaces 1620 which allow software and data to be transferred from the removable storage unit 1622 to the computer system 1600.

The computing device 1600 also includes at least one communication interface 1624. The communication interface 1624 allows software and data to be transferred between computing device 1600 and external devices via a communication path 1626. In various embodiments of the inventions, the communication interface 1624 permits data to be transferred between the computing device 1600 and a data communication network, such as a public data or private data communication network. The communication interface 1624 may be used to exchange data between different computing devices 1600 which such computing devices 1600 form part an interconnected computer network. Examples of a communication interface 1624 can include a modem, a network interface (such as an Ethernet card), a communication port (such as a serial, parallel, printer, GPIB, IEEE 1394, RJ45, USB), an antenna with associated circuitry and the like. The communication interface 1624 may be wired or may be wireless. Software and data transferred via the communication interface 1624 are in the form of signals which can be electronic, electromagnetic, optical or other signals capable of being received by communication interface 1624. These signals are provided to the communication interface via the communication path 1624.

As shown in FIG. 16, the computing device 1600 may further include a display interface 1602 which performs operations for rendering images or videos to an associated display 1630 and an audio interface 1632 for performing operations for playing audio content via associated speaker(s) 1634.

As used herein, the term “computer program product” (or computer readable medium, which may be a non-transitory computer readable medium) may refer, in part, to removable storage medium 1618, removable storage unit 1622, a hard disk installed in storage drive 1612, or a carrier wave carrying software over communication path 1626 (wireless link or cable) to communication interface 1624. Computer readable storage media (or computer readable media) refers to any non-transitory, non-volatile tangible storage medium that provides recorded instructions and/or data to the computing device 1600 for execution and/or processing. Examples of such storage media include magnetic tape, CD-ROM, DVD, Blu-ray Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 1600. Examples of transitory or non-tangible computer readable transmission media that may also participate in the provision of software, application programs, instructions and/or data to the computing device 1600 include radio or infra-red transmission channels as well as a network connection to another computer or networked device, and the Internet or Intranets including e-mail transmissions and information recorded on Websites and the like.

The computer programs (also called computer program code) are stored in primary memory 1608 and/or secondary memory 1610. Computer programs can also be received via the communication interface 1624. Such computer programs, when executed, enable the computing device 1600 to perform one or more features of embodiments discussed herein. In various embodiments, the computer programs, when executed, enable the processor 1604 to perform features of the above-described embodiments. Accordingly, such computer programs represent controllers of the computer system 1600.

Software may be stored in a computer program product and loaded into the computing device 1600 using the removable storage drive 1614, the storage drive 1612, or the interface 1620. The computer program product may be a non-transitory computer readable medium. Alternatively, the computer program product may be downloaded to the computer system 1600 over the communications path 1626. The software, when executed by the processor 1604, causes the computing device 1600 to perform functions of embodiments described herein.

It is to be understood that the embodiment of FIG. 16 is presented merely by way of example. Therefore, in some embodiments one or more features of the computing device 1600 may be omitted. Also, in some embodiments, one or more features of the computing device 1600 may be combined together. Additionally, in some embodiments, one or more features of the computing device 1600 may be split into one or more component parts.

It will be appreciated by a person skilled in the art that numerous variations and/or modifications may be made to the present invention as shown in the specific embodiments without departing from the spirit or scope of the invention as broadly described. For example, the above description mainly presenting alerts on a visual interface, but it will be appreciated that another type of alert presentation, such as sound alert, can be used in alternate embodiments to implement the method. Some modifications, e.g. adding an access point, changing the log-in routine, etc. may be considered and incorporated. The present embodiments are, therefore, to be considered in all respects to be illustrative and not restrictive.

For example, the whole or part of the example embodiments disclosed above can be described as, but not limited to, the following supplementary notes.

(Supplementary Note 1)

A method for monitoring motion in a video stream, the method comprising:
identifying a motion of interest from motion present in a virtual stream, the virtual stream covering an area of the video stream at which motion is present, the motion of interest being a motion that is targeted for monitoring, wherein the area of the video stream being covered is controllable by a pan tilt value of the virtual stream; and
adjusting the pan tilt value of the virtual stream to position the motion of interest at a centre of the virtual stream.

(Supplementary Note 2)

The method for monitoring motion in the video stream according to Supplementary Note 1, further comprising detecting the area at which motion is present in the video stream by disregarding areas of the video stream that are stationary and generating the virtual stream to cover an area of the video stream that is moving.

(Supplementary Note 3)

The method for monitoring motion in the video stream according to Supplementary Note 1, wherein adjusting the pan tilt value of the virtual stream further comprises determining a coordinate corresponding to a centre of the motion of interest in the video stream, and adjusting the pan tilt value of the virtual stream to position the centre of the virtual stream at the determined coordinate.

(Supplementary Note 4)

The method for monitoring motion in the video stream according to Supplementary Note 1, wherein adjusting the pan tilt value of the virtual stream is done in real time.

(Supplementary Note 5)

The method for monitoring motion in the video stream according to Supplementary Note 1, wherein identifying the motion of interest further comprises shutting down the virtual stream if the motion of interest is not identified in the virtual stream.

(Supplementary Note 6)

The method for monitoring motion in the video stream according to Supplementary Note 1, wherein identifying the motion of interest further comprises shutting down the virtual stream if a plurality of motion of interest are identified in the virtual stream, and generating a plurality of new virtual streams, each of the new virtual streams covering an area of the video stream at which each of the plurality of motion of interest is present.

(Supplementary Note 7)

The method for monitoring motion in the video stream according to Supplementary Note 2, wherein identifying the motion of interest further comprises shutting down the virtual stream if the identified motion of interest is stationary for a period of time in the virtual stream.

(Supplementary Note 8)

The method for monitoring motion in the video stream according to Supplementary Note 7, further comprising detecting whether the identified motion of interest is moving and deviating from a previous position, and regenerating the virtual stream in response to the detection.

(Supplementary Note 9)

The method for monitoring motion in the video stream according to Supplementary Note 2, further comprising generating one or more virtual streams each with a frame of a predetermined height and width, each virtual stream covering one or more areas of the video stream at which motion is present.

(Supplementary Note 10)

The method for monitoring motion in the video stream according to Supplementary Note 9, further comprising:
detecting a plurality of areas at which motion is present in the video stream;
dividing the plurality of areas into one or more groups, each group comprising at least two areas, wherein the at least two areas occupy a total height and width in the video stream that do not exceed the predetermined height and width of the frame of the virtual stream respectively; and
generating each of the one or more virtual streams to cover each of the one or more groups.

(Supplementary Note 11)

The method for monitoring motion in the video stream according to Supplementary Note 10, wherein generating each of the one or more virtual streams further comprises:
determining a coordinate for a centre of each of the plurality of areas; and
calculating an average centre coordinate for each group based on an average of the determined coordinate of each of the at least two areas in each group; wherein a centre of the frame of each generated virtual stream is positioned at the average centre coordinate for an associated group.

(Supplementary Note 12)

The method for monitoring motion in the video stream according to Supplementary Note 11, further comprising updating the average centre coordinate for each group in real time, and adjusting the pan tilt value of each virtual stream to position the centre of the frame at the updated average centre coordinate.

(Supplementary Note 13)

The method for monitoring motion in the video stream according to Supplementary Note 9, wherein generating the one or more virtual streams further comprises adjusting the pan tilt value of each virtual stream to position each frame within a boundary of the video stream.

(Supplementary Note 14)

An apparatus for monitoring motion in a video stream, comprising:
a memory in communication with a processor, the memory storing a computer program recorded therein, the computer program being executable by the processor to cause the apparatus at least to:
identify a motion of interest from motion present in a virtual stream, the virtual stream covering an area of the video stream at which motion is present, the motion of interest being a motion that is targeted for monitoring, wherein the area of the video stream being covered is controllable by a pan tilt value of the virtual stream; and
adjust the pan tilt value of the virtual stream to position the motion of interest at a centre of the virtual stream.

(Supplementary Note 15)

The apparatus for monitoring motion in the video stream according to Supplementary Note 14, wherein the memory and the computer program is executed by the processor to cause the apparatus further to detect the area at which motion is present in the video stream by disregarding areas of the video stream that are stationary and generating the virtual stream to cover an area of the video stream that is moving.

(Supplementary Note 16)

The apparatus for monitoring motion in the video stream according to Supplementary Note 14, wherein adjusting the pan tilt value of the virtual stream further comprises determining a coordinate corresponding to a centre of the motion of interest in the video stream, and adjusting the pan tilt value of the virtual stream to position the centre of the virtual stream at the determined coordinate.

(Supplementary Note 17)

The apparatus for monitoring motion in the video stream according to Supplementary Note 14, wherein adjusting the pan tilt value of the virtual stream is done in real time.

(Supplementary Note 18)

The apparatus for monitoring motion in the video stream according to Supplementary Note 14, wherein identifying the motion of interest further comprises shutting down the virtual stream if the motion of interest is not identified in the virtual stream.

(Supplementary Note 19)

The apparatus for monitoring motion in the video stream according to Supplementary Note 14, wherein identifying the motion of interest further comprises shutting down the virtual stream if a plurality of motion of interest are identified in the virtual stream, and generating a plurality of new virtual streams, each of the new virtual streams covering an area of the video stream at which each of the plurality of motion of interest is present.

(Supplementary Note 20)

The apparatus for monitoring motion in the video stream according to Supplementary Note 15, wherein identifying the motion of interest further comprises shutting down the virtual stream if the identified motion of interest is stationary for a period of time in the virtual stream.

(Supplementary Note 21)

The apparatus for monitoring motion in the video stream according to Supplementary Note 20, wherein the memory and the computer program is executed by the processor to cause the apparatus further to detect whether the identified motion of interest is moving and deviating from a previous position, and regenerate the virtual stream in response to the detection.

(Supplementary Note 22)

The apparatus for monitoring motion in the video stream according to Supplementary Note 15, wherein the memory and the computer program is executed by the processor to cause the apparatus further to generate one or more virtual streams each with a frame of a predetermined height and width, each virtual stream covering one or more areas of the video stream at which motion is present.

(Supplementary Note 23)

The apparatus for monitoring motion in the video stream according to Supplementary Note 22, wherein the memory and the computer program is executed by the processor to cause the apparatus further to:
detect a plurality of areas at which motion is present in the video stream;
divide the plurality of areas into one or more groups, each group comprising at least two areas, wherein the at least two areas occupy a total height and width in the video stream that do not exceed the predetermined height and width of the frame of the virtual stream respectively; and
generate each of the one or more virtual streams to cover each of the one or more groups.

(Supplementary Note 24)

The apparatus for monitoring motion in the video stream according to Supplementary Note 23, wherein generating each of the one or more virtual streams further comprises:
determining a coordinate for a centre of each of the plurality of areas; and
calculating an average centre coordinate for each group based on an average of the determined coordinate of each of the at least two areas in each group; wherein a centre of the frame of each generated virtual stream is positioned at the average centre coordinate for an associated group.

(Supplementary Note 25)

The apparatus for monitoring motion in the video stream according to Supplementary Note 24, wherein the memory and the computer program is executed by the processor to cause the apparatus further to:
update the average centre coordinate for each group in real time, and adjust the pan tilt value of each virtual stream to position the centre of the frame at the updated average centre coordinate.

(Supplementary Note 26)

The apparatus for monitoring motion in the video stream according to Supplementary Note 23, wherein generating the one or more virtual streams further comprises adjusting the pan tilt value of each virtual stream to position each frame within a boundary of the video stream.

(Supplementary Note 27)

A system for monitoring motion in a video stream, comprising:
the apparatus for monitoring motion in the video stream according to any one of Supplementary Notes 14 to 26; and
at least one video capturing device.

While the present invention has been particularly shown and described with reference to example embodiments thereof, the present invention is not limited to these example embodiments. It will be understood by those of ordinary skill in the art that various changes in form and details may be made therein without departing from the spirit and scope of the present invention.

This application is based upon and claims the benefit of priority from Singapore patent application No. 10202108637T, filed on Aug. 6, 2021, the disclosure of which is incorporated herein in its entirety by reference.

What is claimed is:

1. A method for monitoring motion in a video stream, the method comprising:
identifying a motion of interest from motion present in a virtual stream, the virtual stream covering an area of the video stream at which motion is present, the motion of interest being a motion that is targeted for monitoring, wherein the area of the video stream being covered is controllable by a pan tilt value of the virtual stream; and
adjusting the pan tilt value of the virtual stream to position the motion of interest at a centre of the virtual stream.

2. The method for monitoring motion in the video stream according to claim 1, further comprising detecting the area at which motion is present in the video stream by disregarding areas of the video stream that are stationary and generating the virtual stream to cover an area of the video stream that is moving.

3. The method for monitoring motion in the video stream according to claim 1, wherein adjusting the pan tilt value of the virtual stream further comprises determining a coordinate corresponding to a centre of the motion of interest in the video stream, and adjusting the pan tilt value of the virtual stream to position the centre of the virtual stream at the determined coordinate.

4. The method for monitoring motion in the video stream according to claim 1, wherein adjusting the pan tilt value of the virtual stream is done in real time.

5. The method for monitoring motion in the video stream according to claim 1, wherein identifying the motion of interest further comprises shutting down the virtual stream if the motion of interest is not identified in the virtual stream.

6. The method for monitoring motion in the video stream according to claim 1, wherein identifying the motion of interest further comprises shutting down the virtual stream if a plurality of motion of interest are identified in the virtual stream, and generating a plurality of new virtual streams, each of the new virtual streams covering an area of the video stream at which each of the plurality of motion of interest is present.

7. The method for monitoring motion in the video stream according to claim 2, wherein identifying the motion of interest further comprises shutting down the virtual stream if the identified motion of interest is stationary for a period of time in the virtual stream.

8. The method for monitoring motion in the video stream according to claim 7, further comprising detecting whether the identified motion of interest is moving and deviating from a previous position, and regenerating the virtual stream in response to the detection.

9. The method for monitoring motion in the video stream according to claim 2, further comprising generating one or more virtual streams each with a frame of a predetermined height and width, each virtual stream covering one or more areas of the video stream at which motion is present.

10. The method for monitoring motion in the video stream according to claim 9, further comprising:
detecting a plurality of areas at which motion is present in the video stream;
dividing the plurality of areas into one or more groups, each group comprising at least two areas, wherein the at least two areas occupy a total height and width in the video stream that do not exceed the predetermined height and width of the frame of the virtual stream respectively; and
generating each of the one or more virtual streams to cover each of the one or more groups.

11. The method for monitoring motion in the video stream according to claim 10, wherein generating each of the one or more virtual streams further comprises:
determining a coordinate for a centre of each of the plurality of areas;
calculating an average centre coordinate for each group based on an average of the determined coordinate of each of the at least two areas in each group; wherein a centre of the frame of each generated virtual stream is positioned at the average centre coordinate for an associated group.

12. The method for monitoring motion in the video stream according to claim 11, further comprising updating the average centre coordinate for each group in real time, and adjusting the pan tilt value of each virtual stream to position the centre of the frame at the updated average centre coordinate.

13. The method for monitoring motion in the video stream according to claim 9, wherein generating the one or more virtual streams further comprises adjusting the pan tilt value of each virtual stream to position each frame within a boundary of the video stream.

14. An apparatus for monitoring motion in a video stream, comprising:
a memory in communication with a processor, the memory storing a computer program recorded therein, the computer program being executable by the processor to cause the apparatus at least to:
identify a motion of interest from motion present in a virtual stream, the virtual stream covering an area of the video stream at which motion is present, the motion of interest being a motion that is targeted for monitoring, wherein the area of the video stream being covered is controllable by a pan tilt value of the virtual stream; and
adjust the pan tilt value of the virtual stream to position the motion of interest at a centre of the virtual stream.

15. The apparatus for monitoring motion in the video stream according to claim 14, wherein the memory and the computer program is executed by the processor to cause the apparatus further to detect the area at which motion is present in the video stream by disregarding areas of the video stream that are stationary and generating the virtual stream to cover an area of the video stream that is moving.

16. The apparatus for monitoring motion in the video stream according to claim 14, wherein adjusting the pan tilt value of the virtual stream further comprises determining a coordinate corresponding to a centre of the motion of interest in the video stream, and adjusting the pan tilt value of the virtual stream to position the centre of the virtual stream at the determined coordinate.

17. The apparatus for monitoring motion in the video stream according to claim 14, wherein adjusting the pan tilt value of the virtual stream is done in real time.

18. The apparatus for monitoring motion in the video stream according to claim 14, wherein identifying the motion of interest further comprises shutting down the virtual stream if the motion of interest is not identified in the virtual stream.

19. The apparatus for monitoring motion in the video stream according to claim 14, wherein identifying the motion of interest further comprises shutting down the virtual stream if a plurality of motion of interest are identified in the virtual stream, and generating a plurality of new virtual streams, each of the new virtual streams covering an area of the video stream at which each of the plurality of motion of interest is present.

20. (canceled)

21. A non-transitory computer-readable storage medium storing a program for causing a computer to execute processing comprising:
identifying a motion of interest from motion present in a virtual stream, the virtual stream covering an area of the video stream at which motion is present, the motion of interest being a motion that is targeted for monitoring, wherein the area of the video stream being covered is controllable by a pan tilt value of the virtual stream; and
adjusting the pan tilt value of the virtual stream to position the motion of interest at a centre of the virtual stream.
